(19) United States
(12) Patent Application Publication
(10) Pub. No.: US 2004/0163131 A1
(43) Pub. Date: Aug. 19, 2004

(54) Telecommunication feature activation and billing support from a centralized server

(76) Inventor: David S. Benco, Winfield, IL (US)

Correspondence Address: PATTI & BRILL, ONE NORTH LASALLE STREET, 44TH FLOOR, CHICAGO, IL, 60602, US

(21) Appl. No.: 10/356,005

(22) Filed: Jan. 31, 2003

(51) Int. Cl. H04N 7/16; H04N 7/173

(52) U.S. Cl. 725/132; 725/140

(57) ABSTRACT

Feature activation has historically been performed exclusively at the system that will provide the features to subscribers and/or users. The features have been built in as a part of a system software package. Even though the features have been built in, they were only available for use by the system to the extent that licenses for those features had been purchased. When the proper licensing fee is paid, an ON/OFF bit was set to ON in a feature activation table. Features that have numerical use values instead of ON/OFF use multiple bit entries in the feature activation table. The feature activation table was encrypted by the software provider to discourage tampering with or misappropriation of telephone service features. With such an arrangement, feature changes could only be made by sending software provider personnel to the system to load a new feature activation table, which also can with the latest version of the system software. The invention provides a method and apparatus for feature changing from a server, which can be remote and centrally located. With this invention feature changes are made quickly without sending personnel to the system location to effect the change. The system owner can change features as its subscribers change the features they want. The software provider can license features for lines in finer granularity and for short time periods to offer different types of licenses to obtain more revenue.

### BACKGROUND OF THE INVENTION

This invention relates to telecommunication services and, more particularly, to rapid feature activation to keep pace with changes to telecommunication services.

A telecommunication system is a compilation of hardware and software. Referring to FIG. 1: a first example is cellular base station (cell) 20, a second example is radio network controller (RNC) 30, and a third example is telecommunication switch (TSX) 40. The hardware and software of each system provide telecommunication services and features to the subscribers and users of that respective telecommunication system. For example automobile 22 and mobile hand unit 24 are subscribers and/or users of cell 20. Similarly, units 32, 34, 35 are subscribers and/or users of RNC 30, and units 42, 44 and 46 are subscribers and/or users of TSX 40. Each of these systems 20, 30, 40 is bi-directionally connected to a network 10 over which communications are often effected. Only three systems are shown in FIG. 1, but these are shown as representative systems in order to simplify the background and the description of the present invention, while still presenting the subject matter may be completely understood by one of average skill in the art.

The network may be completely owned by the owner of the telecommunication system as in some private branch exchange networks, a completely public network 10, such as the Internet and the public switched telephone network, or in between. Typical telecommunication systems 20, 30, 40 are in the in between category, having an owned network portion and a public network portion. Many local telecommunication service providers are also in the in between category. The result of this is that a large majority of the telecommunication systems 20, 30, 40, etc. are connected to a public network, such as network 10. The public network 10 provides end to end connections, whether each end belongs to a subscriber, i.e. a business or an individual located in a service area of the system 20, 30, or 40, or a user, i.e. a business or an individual not subscribed to the systems 20, 30, or 40 in the service area but none the less use the system to initiate or terminate a communication session.

Each telecommunication system provides services such as local exchange calls, setting-up and/or terminating long distance calls, billing for the services used, etc. Considering the large size of some of the systems and the number of subscribers/users, the hardware and software must be carefully coordinated to provide the services in large quantities. Otherwise, subscribers/users will not be able to place and/or receive their calls. Because of this need to co-ordinate hardware and software of a telecommunication system, the software that runs the hardware typically is designed for a specific system and is loaded into a specific system usually by the software provider. Such custom software provides a very rapid execution rate by the processors within the system.

The software loaded is typically encrypted in part by the software provider. Such encryption serves numerous purposes, but the main purposes served are: to prevent the system owner or other party from expanding the system hardware without having a coordinated software revision, and to define the types and units of service licensed by the software provider to the system owner.

Besides the basic services of setting up a call and terminating a call, are call features. Call features, such as call waiting, call forwarding, voice mail, 911 emergency calling and many others, often make communication between a calling party and a called party more effective. These features are part of the loaded software. These features typically are covered by intellectual property rights of the software provider. Sometimes a third party will license features to the software provider with a pass through license to the service provider end. Often times the loaded software has in it all of the features that the software provider can provide. For a system to have one of these feature available to its subscribers/users, the software has a file by which the call features will be turned on when the service provider makes arrangements with the software provider to do so. The encryption of the call feature file helps ensure that the service provider operates its telecommunication system within the licenses arranged for with and obtained from the software provider.

Software that is encrypted and is to be loaded takes days to weeks to develop, load and test. Some, if not all, of the service providers would rather have a quicker turn-around when the service providers orders new features and/or more subscribers/users to its system. It is highly desirable to have a method and apparatus for updating a system of a service provider within hours instead of days or weeks. It is also highly desirable to have a method and apparatus that allows rapid turnaround of feature upgrades and which safeguards the rights of the software provider, as well as the integrity of the software.

In some systems, service features are controlled by feature activation files (FAFs.). Each FAF controls how optional service features are turned ON in the software of some systems, for example Autoplex® software. Autoplex is a registered trademark of Lucent Technologies Inc., Murray Hill, N.J. Each FAF is a “flat file” which resides on the main processor of a system of a call service provider. The FAF has one entry per optional feature. When customers, such as service providers, purchase optional features, the corresponding entries in the FAF are turned ON, which thereby enables the corresponding optional feature software of the system. The FAF has multiple bit fields so numerical values of subscribers, or ports that are authorized and/or licensed to use service features can be specified.

One step beyond the FAF, a QFAF (Qualified FAF) capability has evolved to support smaller granular feature control, e.g. optional features activated on a per-hardware-component basis. For packet systems, wireless data systems, and others, the system and software providers often desire a more sophisticated control than simply ON/OFF control. Software and system providers would rather be able to charge subscribers/users based on the functionality actually used. Functionality includes such things as processor capability, number of processors, type of resident software, etc. For example, a system owner may want to be able to control the maximum capacity of a system, regardless of the individual power of the processors. For example, for 5ESS® family systems, it would not matter if the system processing power was achieved using ten version-1 processors, two version-2 processors, five version-1 processors and one version-2 processor, or one version-3 processor, the processing functionality would be the same. 5ESS is a registered trademark of Lucent Technologies, Inc., Murray Hill, N.J. On the other hand, the software provider may desire to set a limit on the maximum number of data calls connected to a system (even if the system is capable of supporting many more data calls), unless the customer pays for that additional functionality. If such finer granularity capabilities were available, the software provider would be able to use licensing arrangements in which revenue is more closely related to the value provided to the service provider, as well as the subscriber/user.

### SUMMARY OF THE INVENTION

The above problems are addressed, and a number of technical advances are achieved in the art, by implementing a method for changing amounts and types of telecommunication service features available to a service provider from a suite of service features by activation of the agreed upon and licensed service features, without requiring additional delivery of software programs. This method replaces the known FAF service feature enabling mechanism with a method that compares a service provider's capabilities and requested level of service features and activates the agreed upon service features from a central server maintained by the software provider. The enabling data is sent as a response to a request message from the service provider's system. Encryption is used and arranged for in order to discourage unauthorized modifications by service providers or third parties. The invention described herein centralizes the data for all service providers, which provides usage data that is used by the software and hardware providers to prepare future licenses and hardware to the service providers. Benefits of the present invention include highly cost-reduced software development, testing, and administration costs (software creation, shipping, etc.) and additional revenue generation from more secure and finer grained control of service provider software. In addition to the cost savings and advantages described above, the invention may also provide for other software/technology companies besides telecommunication software.

In accordance with a specific aspect of the invention, a method is established in which each processor has a unique ID (e.g., an IP address) and each software application has a unique ID. A central (e. g. a world-wide, IP-connected) server which contains a customer/product database of each processor (i.e., hardware) and software IDs.

During a boot-up process at a customer site, each system software application sends an encrypted data packet consisting of the hardware ID, software ID, and other application-relevant data to the software provider's central server. This is referred to as a request message. A database on the central server is able to identify the customer and the customer's system, compare the configuration/payment limitations, and return an encoded datagram to the service provider's processor that indicates the level of performance to be supported. That level may be anywhere from none to full. This central server and a datagram mechanism can control a virtually unlimited number of software applications and can also be used to support automated software update capability. The authorization cycle between a service provider's system and a software provider's central server is also run periodically after boot up.

In accordance with another aspect of the invention the aforementioned problems are addressed and an advance in the art achieved by providing a network system which has multiple local systems that provide telecommunication service features to users of the multiple local systems. Each of the local systems is bi-directionally attached to a network. An activation server is also bi-directionally attached to the network. The activation server and each of the multiple local systems communicate at least once at boot up so the activation server can authenticate each of the multiple attached local systems, respectively. The activation server compares a status of hardware and software at each local system stored at activation server with a status message received from each of the multiple local systems. If the hardware and software status stored at the activation server agrees with the hardware and software status communicated by each local system, then the activation server sends a message back through the network that stores data in each local system respectively, to activate service features thereof

Also in accordance with the invention, a method of adding telecommunication service assets and investments without the extra time require to rewrite the service software to support the added assets. Thus, preserving a telecommunications service provider's investment in existing hardware and software, yet providing the ability to expand quickly with growing markets.

### BRIEF DESCRIPTION OF THE DRAWINGS

The foregoing advantageous features of the invention will be described in detail and other advantageous features will be made apparent upon reading the following detailed description that is given with reference to the several figures of the drawings, in which:

FIG. 1 shows a simplified block diagram of telecommunication systems operating as presently known.

FIG. 2 shows a simplified block diagram of a telecommunication systems operating according to the present invention.

FIG. 3 is a flow diagram of transactions transferred between telecommunication systems and a server according to another aspect of the present invention.

### DETAILED DESCRIPTION

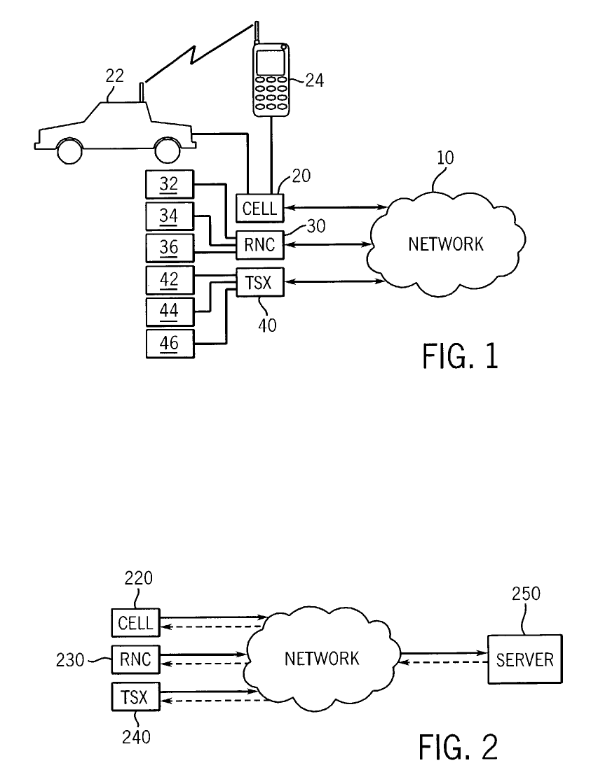

FIG. 2 shows a cell system 220, an RNC 230 and a TSX 240 that are similar in many ways to the cell system 30, the RNC 30 and the TSX 40 of FIG. 1. Like cell system 20, RNC 30 and TSX 40, cell system 220, RNC 230 and TSX 240 are connected to a network 210 that is very similar to the network 10 of FIG. 1. By means of the network 210 communications can be passed among cell system 220, RNC 230 and TSX 240, just like the network 10 of FIG. 1. The most significant difference between FIG. 1 and FIG. 2 is server 250 in FIG. 2. Server 250 in concert with the operation of cell system 220, RNC 230 and TSX 240 enables most of the advantageous operations of the present invention.

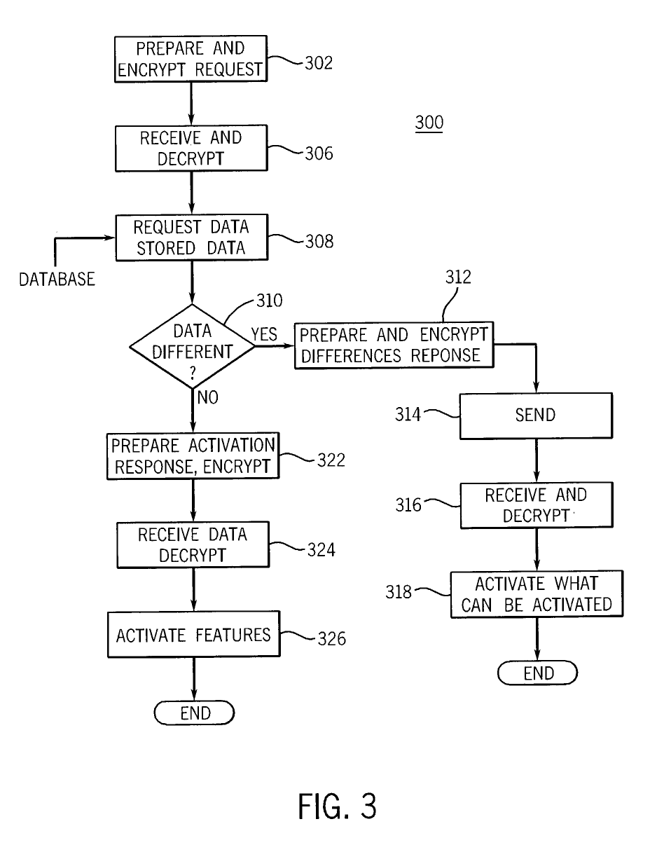

Referring now to FIG. 3, when cell system 220 (or RNC 230 or TSX 240) is cycled up from a down condition cell system 220 must attach to the network 2 1 0. Attaching to the network 210 is important because no data will be communicated to cell system 220 until cell system 220 has been recognized by the network 210 as up and ready to handle data. If network 210 is an Internet network, the Internet nodes will refuse to send data to a node address that is not listed as active in the network. After attaching to the network, cell system 220 prepares and sends a service authorization request as a first step 302 in the activation method 300. The request goes through network 210 to activation server 250. Each service authorization request message contains: identification (ID) of the cell server 220 by a unique string of numbers or alpha-numeric characters. For example, if network 210 is the Internet this string could be an IP address. Every hardware processor has a processor identification (PID) string, part of which may be fixed in ROM or similar device, and every software unit has a software (SID) string, also. In order to have sufficient number of unique IP addresses available to support this method of operation, it is preferable that Internet Protocol V6 with its larger address space be used. The utilization of the Internet or a similar global data communications IP network provides near-instantaneous verification of these IDs. Even if it takes minutes, the method 300 helps save a significant amount of time and expense over the encrypted custom software upgrades provided by the known upgrade techniques.

As mentioned previously, the IDs assigned to hardware units and software units are unique and parts of these IDs are difficult to change. After receiving a request message and decrypting the request message at step 306, these IDs, PIDs and SIDs from the request message are held and the server stored IDs, PIDs and SIDs are retrieved and held, step 308. These server stored data are services that were been authorized prior to receipt of the request message. Next, the two sets of data are compared in step 310. Since the IDs are unique, the only ways there could be duplicate entries is for a system returning after updates and/or maintenance and record keeping has not caught up with actions in the field. That being the case, the ID, PIDs and SIDs that are duplicates are assumed to be the latest and duplicates are overwritten. If software from one system is loaded on a nearly identical system for any reason, there will be inconsistencies among the ID, PIDs and SIDs, and in such cases, the request message is not authorized by the server 250. If the inconsistencies are minor, the request message is authorized in part and not authorized in part. When authorization is not granted, the requested service is not authorized by the message sent back to the system in response to the request. Either way, the method moves to step 312 when there are differences. Notice of non-authorization is returned to the requesting system when applicable, in step 314. This notice may be a complete denial of the request, or it may just a non-actuation of the non-authorized software service features. This message is encrypted to discourage tampering. At step 316, the response is received and decrypted by the requesting system. Since the software loading and booting personnel work with or even for the software provider, a non-authorization of one or more service features on some or all of the system hardware will be discovered and corrective action will be effected by technical personnel as quickly as possible at step 320. At this point, the next step is up to the service provider, but it often will be an agreement, the details of which are entered into server 250, and a return to step 302.

If there are no differences at comparison 310, the method continues to step 322 where each actuation response, like each actuation request is encrypted to prevent tampering and to help maintain some configuration control of the software of the service software provider. The actuating response is sent through the network 210 to the requesting system. At step 324 the response is received and decrypted by the requesting system at step 324 to get the actual actuation data. At step 326, the actuation data is loaded into and saved by the service actuating portion of the service software running on the requesting system.

While the description above uses the example of cell system 220, those of average skill in the art will recognize that the same request-authorization/denial response method applies to RNC 230 and TSX 240 interactions with server 250 too. Thus, the method and arrangement of one embodiment of the present invention, allows for the removal of the FAF/QFAF software development time from the software itself. Instead, the FAF/QFAF mechanism is replaced by a “black box” server 250 which can control/enable/disable the system software in an unlimited number of ways over the network, all from one central location as shown in FIG. 2. The central (world-wide, IP-connected) server 250 is maintained with a service provider/product database of authorized PIDs and SIDs for which the service provider has the right to or is licensed to use. During the boot-up process (or periodically) at a customer site, each Autoplex software application sends an encrypted data packet consisting of the PID, SID, and other application-relevant data to the central server 250. The database on the server is there to identify the customer, verify the configuration/payment limitations, and return an encoded datagram to the Autoplex processor that indicates the level of performance to support-anywhere from none to full. This mechanism can control a virtually unlimited number of software applications and can also be used to support automated software update capability.

While the specification in this invention is described in relation to certain implementations or embodiments, many details are set forth for the purpose of illustration. For example, in other embodiments of the present invention one or more of the local systems might be replaced with a network element. A network element performs many of the same functions as a local system, but is less independent than a system. Thus, the foregoing merely illustrates the principles of the invention. For example, this invention may have other specific forms without departing from its spirit or essential characteristics. The described arrangements are illustrative and not restrictive. To those skilled in the art, the invention is susceptible to additional implementations or embodiments and certain of the details described in this application can be varied considerably without departing from the basic principles of the invention. It will thus be appreciated that those skilled in the art will be able to devise various arrangements which, although not explicitly described or shown herein, embody the principles of the invention are thus within its spirit and scope.

We claim:

1. A method of activating a feature of a service provider system, comprising the steps of:
sending a message requesting activation of the feature that is available within a service software application from a service provider system to a server;
receiving the request message by the server;
processing the request message into a service activation message by the server, sending the feature activation message from the server to the service provider system;
receiving the feature activation message at the service provider system and
activating the feature provided by the service provider system according to the service activation message.

2. The method of claim 1 wherein the request message contains encrypted data regarding a status of a feature provided by the service provider system when the request message is sent.

3. The method of claim 2 wherein the processing of the request message includes decrypting the encrypted status data.

4. The method of claim 3 wherein the request message has hardware identification numbers for each processor of the requesting system to be used to provide the feature, and the software has identification number for identifying the software to be used to provide feature for which activation is requested.

5. The method of claim 4, wherein the server has stored data of the identification numbers of the processors and the identification number of the software for which license terms have been obtained; and if the requested service features on the requested processors agree with the stored data, an activation message for the feature is returned from the server;

6. The method of claim 5, if the requested feature on the requested processors do not agree with the stored data, an activation message is sent from the server but the message will only activate the feature on those processors for which the request message and the server stored data agree.

7. The method of claim 6 wherein the server does not activate a feature on a processor if the stored data of the server and the status of the request message do not agree.

8. The method of claim 6 further comprising the step of offering to activate the requested feature for the requested number of processors beyond the number of processors in the stored data is sent in the activation message.

9. The method of claim 8 further comprising the step of:
accepting the offer ;and
receiving activation of the feature for those processors for which the offer was made.

10. The method of claim 1 wherein the request message is sent at system boot-up time.

11. The method of claim 1, wherein the request message is sent periodically.

12. A network apparatus comprising:
a system for providing a telecommunication service feature;
the system is bi-directionally attached to a network;
an activation server that is also bi-directional attached to the network;
the activation server and the system communicate at least once so the activation server can compare a status of hardware and software of the system that is stored at activation server with a status message from the system; and
if a hardware and software status that is stored at the activation server agrees with the hardware and software status communicated by the system, then the server stores data in the system to activate the service feature thereof.

13. The network apparatus of claim 12 wherein the system is a cellular system.

14. The network apparatus of claim 12 wherein the system is a radio network controller.

15. The network apparatus of claim 12 wherein the system is a telecommunication switch.

16. The network apparatus of claim 12 wherein if the hardware and software status that is stored at the activation server does not agree with the hardware and software status communicated by the system, then the server does not store data in the system to activate the service feature thereof.

17. The network apparatus of claim 16, wherein the system communicates to the server at system boot up.

18. The network apparatus of claim 16, wherein the system communicates the request message to the server periodically.

19. The network apparatus of claim 18, wherein the request message includes a processor identification number and a software identification number, both of which are unique.

20. The network apparatus of claim 16 wherein the request message is encrypted in part and the server activation message is encrypted in part.
